(19) United States
(12) Patent Application Publication
(10) Pub. No.: US 2023/0376938 A1
(43) Pub. Date: Nov. 23, 2023

(54) System and Method for NFT-based Trading Card Assets

(71) Applicants: James Tyler Frix, Athens, GA (US); Matthew Taylor Hoots, Watkinsville, GA (US); Richard Rivera, Atlanta, GA (US); Justin Williams, Kennesaw, GA (US)

(72) Inventors: James Tyler Frix, Athens, GA (US); Matthew Taylor Hoots, Watkinsville, GA (US); Richard Rivera, Atlanta, GA (US); Justin Williams, Kennesaw, GA (US)

(21) Appl. No.: 18/119,702

(22) Filed: Mar. 9, 2023

Related U.S. Application Data
(60) Provisional application No. 63/342,976, filed on May 17, 2022.

(51) Int. Cl. G06Q 20/36; G06Q 20/38; G06Q 30/02

(52) U.S. Cl. CPC G06Q 20/3672; G06Q 20/389; G06Q 30/0278

(57) ABSTRACT

Disclosed is a system and method for minting, aging, storing, grading, and trading NFT-based trading cards in a way that mimics that of “real” tangible trading cards. Embodiments of the solution may comprise generation of an NFT-based trading card asset by minting a nonfungible token (NFT) representative of an initial digital content operable to be visually displayed on a computing device. The minted NFT-based trading card asset is recorded on a blockchain and comprises a smart contract that includes a degradation algorithm, the degradation algorithm operable when executed to modify the initial digital content into a derivative digital content.

### BACKGROUND

Blockchain technology uses a distributed ledger system in which the data associated with transactions is cryptographically encoded and stored as blocks in the ledger. In the distributed ledger, the blocks are cryptographically linked to one another to form a “chain” in such a way that data stored in the ledger is virtually impossible to delete or modify or counterfeit. The ledger is “distributed” in that every node on the blockchain network has a copy of the ledger and receives a copy of the updated ledger any time a new transaction on the blockchain is performed and the corresponding cryptographically-encoded data is added as a block on the chain.

Each user, i.e., node, on the network has a private key and a public key. The public keys are used by the nodes on the network to identify and communicate with one another, whereas each user's private key, which is not known to the other users of the network, is needed to perform transactions. The public and private keys are used in cryptographic hashing algorithms to perform transactions that result in the cryptographically-encoded blocks being added to the chain once they have been validated. In general, when a user requests a transaction on the network, such as minting a non-fungible token (“NFT”), a cryptographically-encoded block is created and broadcast to all of the nodes on the network. Nodes of the network have processors that perform a consensus algorithm that processes the block to validate it. Once the block is validated, it is added to the ledger and the updated ledger is broadcast to all the nodes of the network.

Blockchain networks vary depending on the type of blockchain technology used, but they all have the above attributes in common. Because it is virtually impossible to delete or modify or counterfeit data stored in the blockchain, blockchain networks are well suited for use in performing a variety of business transactions and for transacting cryptocurrency. In cryptocurrency blockchain networks, fungible tokens (FTs) represent the currency that is transacted, whereas in other types of blockchain networks non-fungible tokens (NFTs) are used to represent non-fungible items, such as collectible items (e.g., baseball cards, artwork, etc.), which can often be purchased on the network using cryptocurrency, held, traded, bought, and sold. FTs and NFTs are cryptographically-encrypted, and transactions that involve them become cryptographically-encrypted blocks of the distributed ledger.

Interestingly, technology that leverages blockchains for minting and recording NFTs has exploded in recent months. One popular use of NFTs is to cryptographically encode a collectible item, such as a unique representation of a generative digital art (see, for example, “Chromic Squiggles” at https://chromie-squiggles.com/) or, as mentioned above, a unique artwork creation or a collectible trading card. Once a digital collectible is minted as an NFT, the NFT and the user it is associated with (actually, the digital wallet of the user), is recorded on the blockchain. The purchaser (i.e., the digital wallet holder) owns the NFT once minted and so owns and controls the unique collectible represented by the NET.

Turning back to the use of NFTs for digital trading cards, the use of NFTs to digitally represent, store, and securely trade or sell a trading card has expanded the trading card industry beyond the tangible. NFT technology enables the trading card industry to easily authenticate an NFT-based trading card, secure its storage against theft, and validate its ownership—all challenges for the industry on the tangible side of trading cards. But, as any trading card enthusiast will explain, the satisfaction that comes from collecting tangible trading cards finds its source in factors and measurables beyond the reach of a digital rendering. It's all about the rarity of the card, its condition relative to other cards of the same content, its number in a series (#11 of 100 or #1213 of 10,000 for example), and even its chain of ownership or title.

Like anything, the value of a tangible trading card is dictated by supply and demand. Certainly, a high demand trading card in low supply will enjoy a certain value that reflects its rarity. Beyond the rarity factor, however, the ultimate value of a trading card derives from its grade. For example, a nearly perfect trading card, with four perfectly sharp corners, sharp focus on its content, and full original gloss on the card may be certified as a “Gem Mint” grade, assuming that it also is devoid of imperfections more common in other trading cards of its ilk like staining, print imperfections, and misalignments (see, for example, the 10-point PSA grading scale viewable at the time of this writing at https://www.psacard.com/resources/gradingstandards#cards). On the other end of the spectrum, a “well loved” version of the same trading card with creases, tears, stains, and worn corners may be certified as a grade of “Poor.” There are numerous grades ranging between Gem Mint and Poor, with the value difference between any one grade and another for a given trading card being significant in some cases.

NFT-based trading cards, because they are perfect digital renderings, are immune to the effects of time, weathering, and “love of ownership” to which tangible cards are subjected, and thus may not offer the same experience and appeal to collectors as do tangible trading cards. Therefore, there is a need in the art for a system and method of minting, aging, storing, grading, and trading NFT-based trading cards in a way that mimics that of “real” tangible trading cards.

### SUMMARY

The present disclosure describes various embodiments, as well as features and aspects thereof, of a system and method for minting, aging, storing, grading, and trading NFT-based trading cards in a way that mimics that of “real” tangible trading cards.

A system and method according to the solution may comprise generation of an NFT-based trading card asset by minting a nonfungible token (NFT) representative of an initial digital content operable to be visually displayed on a computing device. The minted NFT-based trading card asset is recorded on a blockchain and comprises a smart contract that includes a degradation algorithm, the degradation algorithm operable when executed to modify the initial digital content into a derivative digital content. The initial digital content in a preferred embodiment may represent one of a sports trading card, a gaming card, and a ticket, although other subject matters for the digital content will occur to those of skill in the art.

A first grade may be assigned to the initial digital content, wherein the first grade is associated with a grading system and is representative of a first visual defect dataset associated with the initial digital content. Subsequently, in response to a triggering event, the degradation algorithm may self-execute to generate a derivative digital content having a second visual defect dataset. A second grade may be assigned to the derivative digital content, wherein the second grade is also associated with the grading system and is representative of the second visual defect dataset associated with the derivative digital content. After the derivative digital content is generated, the blockchain may be updated to record that the NFT now represents the derivative digital content. A visual defect dataset that informs how the degradation algorithm generates a derivative digital content may cause the derivative digital content, when visually displayed, to represent a trading card that comprises one or more of a tear, a stain, a crease, a worn corner, a fade, a discoloring, and a loss of gloss. Other “defects” are envisioned and will occur to those of skill in the art. A given defect may worsen in its application to the digital content from one derivative digital content to the next.

A triggering event that causes the degradation algorithm to execute and generate a modified or derivative general content may be, but is not limited to being, the act of rendering a digital content, selling the NFT, trading the NFT, or in response to an encoded time lapse or blocks lapse (time on the blockchain can be traced to the number of blocks which have been added to the chain, hence “blocks lapse”). To mitigate the amount of degradation of the visual presentation of the digital content from one application of the degradation algorithm to the next, the method and system may provide for linking a protective device NFT to the NFT-based trading card asset. In such embodiment, the linked protective device NFT operates as an input to the degradation algorithm to affect the scope of the second visual defect dataset that is applied by the degradation algorithm to generate a derivative digital content in response to a triggering event. The exemplary embodiment may further assign a second grade to the derivative digital content, wherein the second grade is associated with the grading system and is representative of the second visual defect dataset associated with the derivative digital content. The blockchain may be updated to record that the NFT represents the derivative digital content. In this way, an NFT-based trading card asset may be serially modified in response to triggering events to imitate the “wear and tear” that a tangible trading card might experience in response to real life triggering events (like handling, unsecure storage, etc.). The initial digital content may be operable for display without visual defect, however, a derivative digital content of the same, when visually displayed, may represent the content (such as a trading card) according to application of the second visual defect dataset associated with the derivative digital content. A visual defect set may be associated with the depicted underlying “material” of the card. For instance, defects for a standard “paper” could comprise, but would not be limited to comprising, one or more of a tear, a stain, a crease, a worn corner, a fade, a discoloring, and a loss of gloss. Defects for a “metal” card could comprise rust effects, bends, stress and strain lines, and breaks. Defects for a “glass” card could comprise crack lines, breaks, chipped corners, a loss of clarity, an introduction of opacity in spots or of the entire card, etc.

### BRIEF DESCRIPTION OF THE SEVERAL VIEWS OF THE DRAWING

In the drawings, like reference numerals refer to like parts throughout the various views unless otherwise indicated. For reference numerals with letter character designations such as “320a” or “320b,” the letter character designations may differentiate two like parts or elements present in the same figure. Letter character designations for reference numerals may be omitted when it is intended for a reference numeral to encompass all parts having the same reference numeral in all figures.

FIG. 1 is a logical flowchart illustrating an exemplary embodiment of a method for generating NFT-based trading card assets according to the solution;

FIG. 2 is a logical flowchart illustrating a subroutine for weathering NFT-based trading card assets;

FIG. 3 is a block diagram of the blockchain network of the present disclosure in accordance with a representative embodiment of the solution for minting, aging, storing, grading, and trading NFT-based trading card assets;

FIG. 4 is a more detailed block diagram of the NFT-based trading card asset platform depicted in the FIG. 3 illustration; and

The Appendix provides an exemplary rendering of the digital content of an NFT-based trading card asset according to an exemplary embodiment of the solution, shown in stages of an exemplary “degradation” according to the application of a degradation algorithm dictated by a smart contract associated with the NFT-based trading card asset.

### DETAILED DESCRIPTION OF VARIOUS EMBODIMENTS

The word “exemplary” is used herein to mean “serving as an example, instance, or illustration.” Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” “platform” and the like are intended to refer to a computer-related entity, either hardware, firmware, a combination of hardware and software, software, or software in execution and represent exemplary means for providing the functionality and performing the certain steps in the processes or process flows described in this specification. For example, a module may be, but is not limited to being, a process running on a processor, a processor, an object, an executable, a thread of execution, a program, a node, a server and/or a computer. One or more components may reside within a process and/or thread of execution, and a module or component or database, etc. may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

As used in this description, the term “smart contract” refers to a self-executing application associated with an NFT-based asset. A smart contract, as understood by one of ordinary skill in the art, may exist as code within a blockchain and be associated with a unique address therein. The coded actions dictated by smart contracts are executed by nodes of a distributed blockchain ledger. Smart contracts function as a set of software created by developers, published at the time of minting an NFT, and work to decide the qualities and functions of the NFT. Additionally, smart contracts may be leveraged to implement a later sale agreement between an NFT owner and a buyer and record the same on a blockchain ledger. Moreover, smart contracts may dictate that royalties (usually in the form of cryptocurrency) be directed to a third party (such as an artist or NFT-minting source) each time a trigger event occurs (such as sale or transfer of the NFT associated with the smart contract). In this way, smart contracts are self-executing and can verify the satisfaction of contract terms as well as execute the terms without need for an intermediary or central authority. Further, and as would be understood by one of ordinary skill in the art of NFTs, metadata of an NFT may point to the blockchain address of an associated smart contract and may hold certain attributes which interact with the smart contract based (such as degradation attributes). Beyond that described above, embodiments of the solution herein for NFT-based trading card assets may leverage a smart contract to execute functionalities of the NFT with which it is associated such as, but not limited to, directing royalty payments, linking to other digital assets, executing and applying an aging or degradation algorithm, etc.

In this description, the terms “mint” and “minting” and the like, when used in a verb form, refer to the process of generating an NFT which includes writing the underlying and associated smart contract code.

In this description, the terms “trading card” and “trading card assets” and “assets” are used interchangeably to refer to a digital content rendered in association with a nonfungible token (I.e., an “NFT”). As one of ordinary skill in the art of NFTs would acknowledge, ownership and control of an NFT may allow for its holder to visually display a uniquely associated digital content. In this way, a digital artwork uniquely associated with an NFT may be rendered for the enjoyment of the NFT owner/holder. In this description, embodiments of the solution are described within the context of digital content in the form of a sports trading card (such as a baseball card featuring a player picture and statistics), however, it is envisioned that embodiments of the solution may be implemented within the context of any digital content category such as, but not limited to, sports trading cards, game-based trading cards (e.g. “Pokemon” cards or “Dungeons and Dragons” cards), commemorative tickets, “prints” of original digital art, etc. As such, it will be understood that the descriptions herein of certain exemplary embodiments of the solution within the context of sports trading cards will not suggest that the scope of the solution is limited to digital sports trading cards.

In this description, the terms “render” and “renderings” and the like refer to a display event of a digital content represented by an NFT. For example, an owner of an NFT that represents a digital content in the form of a baseball card “renders” the baseball card when the digital content is visually displayed on a device.

In this description, the term “grade” is used to refer to a state of presentation for a rendered digital content, except when used in reference to a tangible trading card asset wherein grade refers to the physical condition of the tangible card. As one of ordinary skill in the art of digital content would acknowledge, digital content does not physically degrade—it is what it is and when executed on a suitable electronic device it displays what it is encoded to display. As such, the various “grades” of a digital content represented by an NFT-based trading card asset according to the solution may be mapped to a series of randomly generated, or quasi-randomly generated, derivative digital contents from an initial digital content. Each derivative digital content, being a modification of the initial digital content and/or a modification of a previous derivative digital content of same, may mimic the “grade” of a would-be comparable tangible trading card asset that had degraded or weathered in its physical characteristics over time.

In this description, the term “degradation” is used to describe the process of modifying a digital content associated with an NFT-based trading card asset. Within the scope of the solution, when a digital content is degraded it may be permanently modified to generate a derivative of the digital content. Only the most recent version or derivation of the digital content may be associated with the NFT-based trading card asset and, therefore, subsisting and viewable by the owner/holder of the NFT. Depending on the features of a given digital content (whether it is an initial digital content or a derivation), the digital content may be associated with a grade that categorizes it relative to previous and future derivations.

In this description, the terms “weathering algorithm” and “degradation algorithm” are used interchangeably.

In this description, references are made to the PSA grading standard and the various grade levels defined thereby. Reference to the PSA grades in the description of the exemplary embodiments does not suggest that that the scope of the solution is limited in application to an NFT-based trading card asset system and method that leverages a grading standard based on the PSA standard. It is envisioned that any grading standard, presently known or unknown, might be employed by an embodiment of the solution without departing from the scope of the invention. Additionally, although it is envisioned that preferred embodiments of the solution may leverage a grading standard in order to affix a “grade” to an NFT-based trading card asset, doing so is not required in all embodiments of the solution. In one such exemplary embodiment, this “grade” may be requested by the owner of the NFT trading card at any moment in time. Upon such request, the smart contract would query the algorithm to decode the current “weathering” or “degradation” state of the trading card in question and would then apply a public (on-chain) “grade” to the card as it sits in its current weathering/degradation state. Advantageously, this act of “grading” might even trigger a weathering/degradation event, on-chain, as its real-world equivalent would entail a physical inspection of the asset which could have some small risk of damage associated with it.

The following written description explains various embodiments of a method and system for generating NFT-based trading card assets and, more specifically, for minting, aging, storing, grading, and/or selling/trading NFT-based trading card assets. This written description refers to the appended drawings to supplement the written explanation. As such, the written words should not be construed as limitations. Numerous specific details are explained in the written description and depicted in the drawings to provide an enabling understanding of the various embodiments to a person having ordinary skill in the art of blockchain technology and non-fungible tokens. Some details, however, need not be expressly explained because they would be readily apparent and understood by a person having ordinary skill in the relevant art. For example, a person having ordinary skill in the art would be able to configure a network and code application software for implementation of NFT-based trading card assets according to the solution after reviewing this specification and drawings.

Embodiments of the solution comprise an NFT-based trading card asset system and method useful to, inter alia, mint NFTs of digital content that “weathers” or degrades according to a smart contract algorithm and in view of one or more trigger events. The digital content is “weathered” or “degraded” by and through modification of the digital content into derivative versions of digital content. Each version of the digital content may be associated with, and defined by, a visual defect dataset. For example, a digital content of a visual picture of an athlete may be “degraded” by generating a replacement digital content that is a derivative of the original by virtue of using modified colors and/or introducing an obstructive feature that changes or distorts the visual presentation of the original content (such as by introducing a “tear” in the picture that imitates a tear as if the picture were actually a tangible card). In this way, and advantageously, NFT-based trading card assets generated according to embodiments of the solution may mimic the experience associated with “real life,” tangible trading cards.

It is envisioned that an NFT-based trading card asset may be associated with a smart contract that comprises a degradation algorithm. At the time of minting, the digital content (e.g., a baseball card) represented by the NFT may be rendered by its owner/holder in an initial presentation that is flawless (a “gem” mint) or at least visually “new.” That is, immediately after minting, the digital content may be rendered in a high resolution, for example, and may be perceived unobstructed in any manner. Over time, however, and/or in response to multiple renderings, the quality of the rendering may be degraded by, for example, distorting the resolution of the digital content to imitate gloss reduction, modifying the digital content to introduce representative “tears” or “bends” or “wear marks” or “stains” or “breaks” or “cracks” or other weathering effects specific to the depicted material of the underlying the digital content, etc. In this way, an NFT-based trading card asset may be subjected to a “weathering” process that mimics that which a real life, tangible trading card may experience.

Returning to the time of minting and NFT-based trading card asset, it is envisioned that in some embodiments of the solution the digital content (e.g., a baseball card) represented by the NFT may be rendered by its owner/holder in an initial presentation that, although “new,” is something less than flawless. For example, because newly printed, tangible trading card assets may not necessarily be graded at a perfect ten (a “gem mint”), it is envisioned that embodiments of the solution for NFT-based trading card assets may also mint new NFTs associated with a less than flawless digital content presentation. That is, in some embodiments, a digital content associated with an NFT-based trading card assets may render at an initial grade of “9/10” or even an “8/10.” In such embodiments of the solution, it is envisioned that perhaps only a select few “brand new” NFT-based trading card assets may be associated with a digital content worthy of a “gem mint, 10/10” rating when rendered. Regardless of the assigned grade to the initial digital content at the time of minting, the “starting value” of the digital content degrades or decrements from there according to the various factors and triggers that inform an associated degradation algorithm.

To further mimic a tangible trading card asset, it is envisioned that an NFT-based trading card asset may be protected from degradation, or its rate of degradation mitigated, through application of a digital version of a protective device such as a glass case, or plastic case, or shoebox, or trading card album, or climate controlled safe, etc. For example, the smart contract of an NFT-based trading card asset may link the asset to a related NFT representative of a storage device or protective device. The type of storage device may work as an input to the degradation algorithm of the NFT-based trading card asset in order to apply a reduced degradation factor.

For example, an NFT-based asset according to the solution that incorporates a smart contract that includes a time-based weathering algorithm such that the digital content automatically degrades in quality or presentation with time, and without regard for rendering events, may be linked to a highly protective storage device NFT representative of an air-tight glass case. The presence of a link to the storage device NFT may be an input to the degradation algorithm of the NFT-based trading card asset that works to delay or slow or altogether stay the time-based weathering effect. In this way, by “placing” the exemplary NFT-based trading card asset in the storage device NFT representative, in this example, of an airtight glass case, the weathering effects of time may be guarded against and the “grade” of the NFT-based trading card asset secured, just like the weathering effects of time are guarded against when a real life, tangible card is stored in a high quality, dedicated, airtight glass case.

More to the above, it is envisioned that an NFT-based trading card asset according to the solution may incorporate a metadata section for defining “degradation speed” and the dataset stored therein could be a series of numbers that alter the degradation speed of that card: 0.25 speed, 0.5 speed, 0.75 speed, 1 speed (normal), 1.25 (25% faster degradation), 1.5 speed (50% faster than normal degradation), etc. The degradation algorithm may be informed by the degradation speed in its generation of derivative digital contents. Advantageously for those embodiments of the solution that leverage linked protective device NFTs, the degradation speed input from the metadata of the NFT to the degradation algorithm of the smart contract may be adjusted to a relatively “slower” speed of degradation, thereby driving the algorithm to generate less severe and/or less frequent derivations of the digital content.

Moreover, it is envisioned that storage device NFTs may be coded to work with multiple NFT-based trading card assets and, in doing so, may effectively mimic real life storage devices commonly used by collectors of tangible trading cards. For example, one type of storage device NFT according to certain embodiments of the solution may be representative of a shoe box (as I'm sure the reader can appreciate, a shoe box is an iconic storage device of tangible trading card assets). Mirroring a real world experience, the “shoe box” storage device NFT may be configured for association with a large number of NFT-based trading card assets (perhaps 100 assets) and provide a relatively low degradation mitigation factor to each. That is, because a real-life shoebox may be used to store a lot of trading cards but provide minimal protection against being spilled, fingered, shook around, and the like, the ownership of a “shoe box” level storage device NFT may only provide a minimal degradation mitigator factor to the degradation algorithms of each NFT-based trading card asset linked to the “shoebox.” By contrast, a higher quality storage device like a climate controlled safe deposit box may be represented by a storage device NFT that is linkable to a lesser number of NFT-based trading card assets but advantageously provides for a better degradation mitigation factor as an input to the degradation algorithms of each linked NFT-based trading card asset.

An exemplary degradation algorithm comprised within a smart contract of an NFT-based trading card asset according to the solution may provide for the digital content of the NFT-based trading card to be rendered for display in a “flawless” presentation immediately after minting. The act of rendering the digital content, however, may be a factor that triggers the associated degradation algorithm to “age” or “weather” the digital content, if not ever so slightly. As mentioned above, it is envisioned that certain embodiments of an NFT-based trading card asset may build into the smart contract a time-based aging factor that triggers a degradation of the digital content whether it is ever rendered or not.

Absent degradation mitigation factors (such as a protective storage device NFT), the quality of the digital content may be permanently degraded, thereby theoretically driving value out of the NFT-based trading card asset (much like a tangible trading card that has been weathered or aged). It is envisioned that, over time and/or in response to trigger events within the digital environment (such as renderings of the digital content, sales or transfers of the NFT-based trading card asset, de-linking of the NFT-based trading card asset from a protective device NFT, inspecting a NFT-based trading card asset for purposes of assigning an on-chain “grade,” etc.), the grade of an NFT-based trading card asset may be decremented. For example, an exemplary “Gem Mint 10” graded NFT-based trading card asset may, as a result of execution of the degradation algorithm associated with its smart contract, be degraded from its “flawless” grade to a lesser grade (such as, for example, to a “Mint 9” grade, as would be recognized by one of knowledge in the PSA grading standard). To do so, the degradation algorithm may introduce one or more flaws to the digital content indicative of, and resembling, real-life wear such as, for example, a slight wax stain or a discolored white border area the result of “too much light exposure.” Notably, once degraded and recorded as such on the blockchain, any rendering of the digital content of the NFT-based trading card asset will irreversibly reflect the introduced flaws.

Continuing with the example, that same NFT-based trading card asset, having been de-linked from a protective device NFT and rendered over and over again, may be degraded by its smart contract associated degradation algorithm to modify the digital content to introduce “rounded corners” and a “slight crease,” thereby reducing the grade of the NFT-based trading card asset all the way down to a VG3 (a “very good” rating, as would be recognized by one of knowledge in the PSA grading standard).

The exemplary degradation algorithm may continue in this way, degrading the presentation experience of the digital content of the NFT-based trading card asset in response to any number of triggering events or input factors, and degradation mitigation factors (such as a link to a storage device NFT), made relevant at the time of minting. Depending on the degradation algorithm and input factors, the digital content of an NFT-based trading card asset may steadily degrade to a base grade or even to a “lost” status. The “base-grade” could be envisioned as one made up of the contents of the base material depicted in the NFT based trading card asset. For example, a “metal” trading card could be degraded to a final state of “rust-pile” and a “paper” based NFT trading card asset could be degraded to a final state of “dust.” Advantageously, the result is ownership of a digital trading card asset in a way that mimics ownership of a real-life tangible asset. It is further envisioned that this base state “material” (dust, rust, etc.) could be used as a “token” or “currency” that could interact with other base materials and the underlying smart contract itself. For example, it is envisioned that in certain embodiments of the solution accumulating enough “dust” could allow one to “craft” a new NFT-based trading card asset or protection device such as a “shoe-box.” Moreover, the “dust” or “rust” could be used as a currency to purchase other digital or physical assets inside of the project ecosystem. In still other embodiments, “dust” or “rust” could even be used to “renew” one of the underlying damaged, completely degraded, or lost NFT trading card assets.

It is further envisioned that at the time of minting the digital content of the NFT-based trading card asset may be randomly created to actually include flaws, such as to mimic a real-life tangible card that was misprinted or the like. For example, the digital content may be altered by the smart contract at the time of minting, without any requirement of a degradation factor, to include grade qualifiers such as a “printing mark,” or a miscut, or a print defect, or an out of focus presentation, or an off center presentation, etc. It is envisioned that random application of a qualifier to the digital content of a sampling of NFT-based trading card assets may further create scarcity that drives value into the randomly altered assets. Like a collector who purchases a pack of tangible trading cards, acquisition of an NFT-based trading card asset that displays a qualifier aspect in its digital content may be random and rare.

Returning to the aspect of the solution in the form of a protective storage device NFT that may be linked to an NFT-based trading card asset in order to mitigate the amount, frequency, and/or type of degradation dictated by its smart contract degradation algorithm, it is envisioned that a protective device NFT may itself be minted to include certain features such as, but not limited to, a limit as to the number of NFT-based trading card assets that may be linked to it, the amount of mitigation it dictates to the degradation of a linked asset, the type of mitigation it dictates to the degradation of a linked asset, etc. In this way, a “shoe box” protective storage device NFT may be configured to “hold” 100 NFT-based trading card assets with minimum protection from degradation. Similarly, a “picture folder” protective storage device NFT may be configured to “hold” a lesser amount of NFT-based trading card assets, perhaps 50 for example, also with minimum protection from degradation. On the other end of the spectrum, an exemplary protective storage device NFT representative of a single, airtight glass case may be able to “hold” a single NFT-based trading card asset and provide a very high degree of protection against degradation to the digital content as may be driven by the degradation algorithm associated with the asset.

In certain embodiments, the system and method for an NFT-based trading card asset may dictate that an NFT-based trading card asset may not be traded or sold to a buyer without displaying the asset in some manner to the buyer, thereby exposing the NFT-based trading card asset to some risk of degradation according to its smart contract degradation algorithm (to mirror the risk that the owner of a real life tangible trading card asset may bear when putting the asset up for sale or auction).

As described above, the initial grade of an NFT-based trading card asset may be determined randomly at the time of minting; however, it is envisioned that in some embodiments the grade at the time of minting may be purchased— I.e., the buyer of the NFT-based trading card asset may elect the initial grade of the digital content in some embodiments. The grade of an NFT-based trading card asset may be recorded in the metadata of the NFT, as would be understood by one of ordinary skill in the art.

In some embodiments, the degradation of an unprotected NFT-based trading card asset may be set via the smart contract to automatically decrement a grade when the asset is traded or sold. In other embodiments, the degradation algorithm might allow for an initial number of trades and/or renderings before degradation of the digital content begins, or it could encode a percentage chance of a degradation event occurring at the time of a triggering event (for instance, a 1% chance of degradation occurring if the NFT owner elects to have the card “inspected” for a grade to be assigned or a 5% chance of degradation upon trading of the NFT).

It is envisioned that in an exemplary preferred embodiment of the solution that the first application of “weathering” or degradation to the digital content of an NFT-based trading card asset may be randomized. For example, it may be a randomized determination by a degradation algorithm whether the first application of “wear” to the digital content is in the form of a crease, or a rounded corner, or a stain, etc. The next stage of degradation, however, may be dictated by the previous stage such that the weathering effects previously applied to the digital content are eligible to “worsen” in addition to, or in lieu of, applying a new weathering effect to the digital content. In this way, the degradation of the digital content of the NFT-based trading card asset may mimic real life wear and tear on a tangible card, as it is likely that an existing defect in a tangible card (such as, for example, a worn corner from being carried in shoebox) may worsen over time. And so, in such an exemplary embodiment, as the digital content of an NFT-based trading card is degraded, new defects and imperfections may be incorporated into the digital content but existing defects and imperfections may worsen.

It is further envisioned that in some embodiments of the solution that the rate of degradation and/or severity of degradation and/or type of degradation applied to the digital content of an NFT-based trading card asset may be affected by an association of the NFT-based trading card asset with another NFT collection held by the user. As one non-limiting example, the associated collection may be in the form of a protective device NFT configured to be linked to a plurality of NFTs, as previously described. In another non-limiting example, the associated collection may be any collection of NFTs, whether related to the NFT-based trading card asset or not, designated to be associated with the NFT-based trading card asset. In this way, in certain embodiments, associating or linking an NFT-based trading card asset to an NFT collection may provide an input to the smart contract degradation algorithm that works to modify degradation factors of the digital content of the NFT-based trading card asset such as by slowing a default rate of degradation.

Advantageously, it is envisioned that embodiments of the solution may provide for features and aspects that drive value into given NFT-based trading card assets beyond the subject matter of the initial digital content itself, the level of degradation, the scarcity, etc. For example, it is envisioned that an athlete associated with a given NFT-based trading card asset (e.g., an NFT-based trading card asset with a digital content of a baseball card featuring a baseball player) may digitally “sign” an owner/holder's NFT-based trading card asset by causing a signature NFT to be minted and linked to the owner/holder's NFT-based trading card. As one example of how digitally signing the NFT-based trading card asset may be accomplished, the athlete and the owner/holder may physically “bump” phones in order to trigger the signature event. As one of ordinary skill in the art of phone bumping technology would recognize, a pair of phones running a “bump” or “tap” application, when physically bumped, may detect the repercussion of the bump and, in response, provide a unique ID and geographic location to a bump service. The bump service, recognizing the geographic co-location of the bumped phones, may trigger some event or data transfer in response. In this way, the bump service may cause a signature NFT associated with the athlete (the athlete being associated with the phone ID) to be minted on behalf of the owner/holder of the NFT-based trading card asset (the owner/holder being associated with the other phone ID). The signature NFT may then be associated with crypto wallet of the owner/holder and linked to the NFT-based trading card asset. Recognition of the linked signature NFT by the smart contract of the NFT-based trading card asset may cause the digital content associated with the NFT-based trading card asset to be modified to include a visual representation of the athlete's signature. As one of ordinary skill in the art would recognize, the digitally signed NFT-based trading card asset may be more valuable than an unsigned NFT-based trading card asset with otherwise comparable digital content. Moreover, because the smart contract of the NFT-based trading card asset may include a royalty formula for pushing value to a digital wallet of the athlete, digitally signing the NFT-based trading card asset may work to increase royalty payments enjoyed by the athlete.

Another feature of embodiments of the solution that may be leveraged to drive value into given NFT-based trading card assets is the ability to record and verify past ownership, or chain of title, of any given NFT-based trading card asset. In this way, a certain NFT-based trading card asset may garner additional value over a comparable asset for no other reason than a certain owner/holder has once held and controlled that specific asset. As a non-limiting example, a given specific NFT-based trading card asset having in association with it a digital content of a baseball card featuring a famous athlete may be more valuable if the chain of title for that given specific NFT-based trading card asset includes the featured athlete.

The exemplary features of embodiments of the solution that are described above, for the most part, envision “on chain” interactions and trigger events such as trading, inspecting, or selling NFT-based trading card assets that work to “alter” the digital content of an NFT-based trading card asset via inputs to the weathering/degradation algorithm. It is further envisioned, however, that “off chain” or “real world” events may also be leveraged as trigger events to cause modification or derivation of the digital content represented by an NFT-based trading card asset. For example, attending a sporting event such as a football game may be leveraged to cause some derivation of digital content of an NFT-based trading card asset held by the attendee. As a non-limiting example, recognition by the system of the owner/holder's physical presence (I.e., confirmation that the owner/holder's user device is present) may be used as a trigger to alter the digital content of the NFT-based trading card asset, such as by “tearing” it like a ticket stub, marking it in some way, etc.

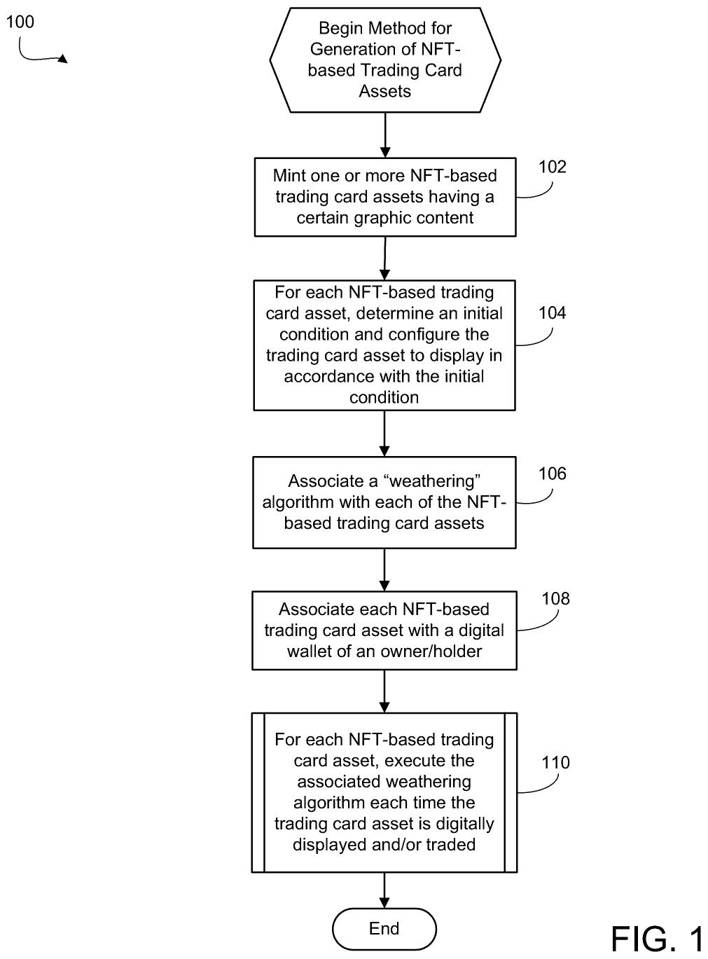

Turning now to the illustrations, FIG. 1 is a logical flowchart illustrating an exemplary embodiment of a method 100 for generating NFT-based trading card assets according to the solution. Beginning at block 102, one or more NFT-based trading card assets having a certain graphic content are minted. For example, within the context of sports trading cards, a host platform may mint a predetermined number of NFT-based trading card assets representative of digital content that, when rendered, displays a picture of a particular athlete and associated statistics (see, for example, the exemplary NFT-based trading card assets provided in the Appendix). Notably, and as would be understood by one of ordinary skill in the art, the minting of each of the NFT-based trading card assets is subject to a smart contract entered into by the purchaser/holder of each NFT-based trading card asset.

Next, at block 104, which occurs commensurate with the time of minting, for each NFT-based trading card asset, an initial condition of the digital content associated with the NFT-based trading card asset is determined. Consistent with that which has been previously described, the condition of the digital content may be associated with a grade, the grade being defined by a dataset of visual defects associated with the digital content. A “high” grade of the digital content may be essentially devoid of visual defects such that, if and when rendered for display, the digital content would mimic a presentation of a high-grade real life, tangible trading card asset. It is envisioned that some embodiments of the solution may provide for a purchaser to select the initial grade at the time of minting, while other embodiments may randomly determine the initial grade of the digital content, while still other embodiments may default to a highest grade for the initial grade of the digital content.

At block 106, which also occurs commensurate with the time of minting, a “weathering” or degradation algorithm is incorporated into the smart contract of the NFT-based trading card asset. As will become clearer from the description that follows, the degradation algorithm, when executed from time to time, may permanently modify the digital content of the NFT-based trading card asset into a derivative digital content that has an amended visual defect dataset. In doing so, the modification of the digital content to create a derivative digital content that includes more visual defects, or more extreme visual defects, may cause a decrement of grade for the NFT-based trading card asset.

At block 106, the minting process is completed by association of the NFT-based trading card asset with the digital wallet of the owner/holder who is party to the smart contract. As one of ordinary skill in the art of blockchain technology would understand, the ID of a digital wallet exists on a blockchain(s) and is publicly identifiable. An owner of a digital wallet may hold any number and type of NFTs and FTs in a digital wallet.

At subroutine or process block 110, the digital content of the NFT-based trading card asset may be modified into a derivative digital content each time the degradation or weathering algorithm embedded in the smart contract executes. Depending on the particular degradation algorithm, a derivative digital content may be generated and recorded on the blockchain in association with the NFT-based trading card asset each time the digital content is displayed and/or traded and/or sold. Other factors or inputs to the degradation algorithm may affect the rate and/or type and/or amount of degradation exemplified by a derivative digital content as compared to its previous state or grade.

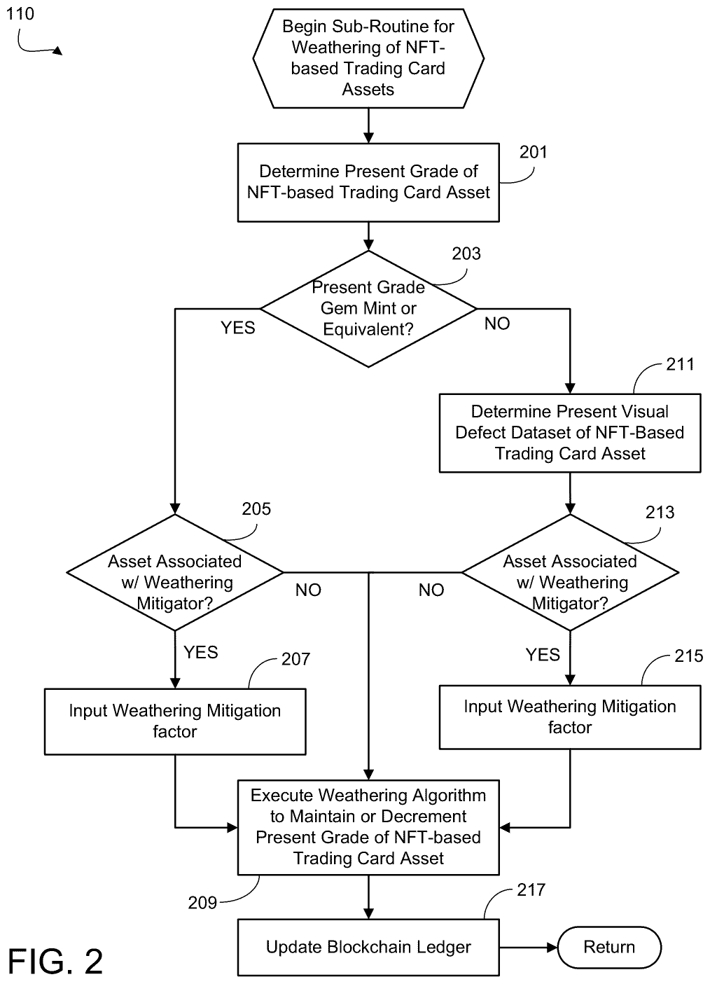

FIG. 2 is a logical flowchart illustrating the subroutine 110 for weathering NFT-based trading card assets. Beginning at block 201, the subroutine 110 may first determine the present grade of the digital content represented by the NFT-based trading card asset. As previously described, the grade of a digital content may be associated with a visual defect dataset of the digital content. In this way, a newly minted digital content may be of a high grade with a zero visual defect dataset, thereby configured to be rendered in a “perfect” display without blemish or flaw (akin to a brand new, flawless tangible trading card asset). By contrast, a digital content that has been subjected to a degradation algorithm of its NFT smart contract from time to time may include a visual defect dataset that is associated with a lesser grade.

At decision block 203, the subroutine 110 may determine if the present grade of the digital content is of a highest possible grade (I.e., a “Gem Mint”), such as may be the grade of the digital content upon completion of the minting process and before being rendered and/or subjected to a degradation event. If “YES,” the subroutine 110 continues to decision block 205 where it is determined whether the NFT-based trading card asset is associated with, or the beneficiary of, any weathering mitigator such as, for example, a protective device NFT. If “YES,” the subroutine 110 continues to block 207 where weathering mitigation factors associated with the weathering mitigator(s) are input to the weathering algorithm at block 209. Returning to the decision block 205, if the NFT-based trading card asset is not associated with, or the beneficiary of, any weathering mitigator then the subroutine 110 proceeds directly to block 209 without input of any weathering mitigation factors to the weathering algorithm. At block 209, the weathering algorithm is applied to the digital content of the NFT-based trading card asset to generate a derivative version of the digital content that may introduce new visual defects to the digital content and/or worsen the presentation of previously introduced visual defects. As a non-limiting example, a stain introduced by the previous derivative digital content version may be increased in size and/or intensity. Next, at block 217, the modified or derivative digital content may then be recorded on the blockchain in association with the NFT-based trading card asset.

Returning to decision block 203, if the subroutine 110 determines that the present grade of the digital content of the NFT-based trading card asset is some grade less than an initial “Gem Mint” grade, I.e. that the digital content is a derivative digital content that includes a visual defect dataset of some extent, the subroutine 110 follows the “NO” branch to block 211 and the nature of the visual defect dataset is determined. Next, at decision block 213, the subroutine 110 determines whether the NFT-based trading card asset is associated with, or the beneficiary of, any weathering mitigator such as, for example, a protective device NFT. If “YES,” the subroutine 110 continues to block 215 where weathering mitigation factors associated with the weathering mitigator(s) are input to the weathering algorithm at block 209. Returning to the decision block 213, if the NFT-based trading card asset is not associated with, or the beneficiary of, any weathering mitigator then the subroutine 110 proceeds directly to block 209 without input of any weathering mitigation factors to the weathering algorithm. At block 209, the weathering algorithm is applied to the digital content of the NFT-based trading card asset to generate a derivative version of the digital content that may introduce new visual defects to the digital content and/or worsen the presentation of previously introduced visual defects. If there was a visual defect dataset identified at blocks 203/211, the weathering algorithm of block 209 may be biased to worsen an existing defect in lieu of introducing a new defect. As a non-limiting example, a stain introduced by the previous derivative digital content version may be increased in size and/or intensity. Advantageously, such bias in the degradation algorithm may provide for a more accurate representation of the experience of owning a real tangible trading card asset as existing defects are likely to worsen over time (worn corners, for example, get “more worn” over time, not less). Next, at block 217, the modified or derivative digital content with its updated visual defect dataset may then be recorded on the blockchain in association with the NFT-based trading card asset.

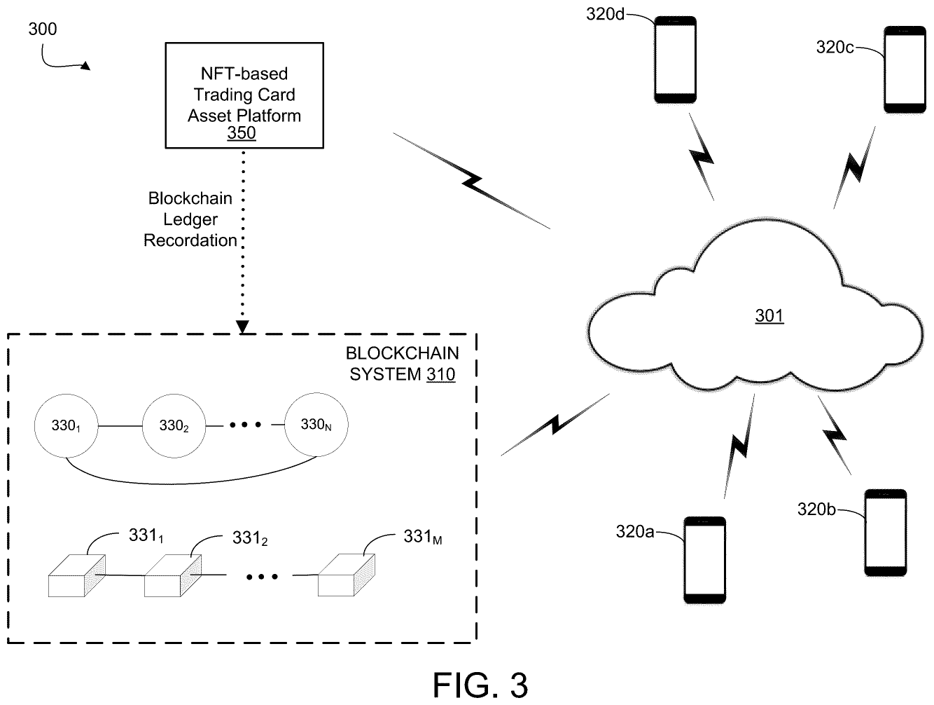

FIG. 3 is a block diagram of the blockchain network 300 of the present disclosure in accordance with a representative embodiment of the solution for minting, aging, storing, grading, and trading/selling NFT-based trading card assets. The blockchain network 300 comprises a blockchain system 310 comprising nodes 330₁ through 330_{N}, where N is a positive integer that is greater than or equal to 1. Each node comprises one or more processors that perform the processes necessary for recording transactions and updating the blockchain. A transaction may be, for example, the minting or trading or sale of an NFT-based trading card asset, a protective device NFT, etc. The blockchain system 310 is in communication via a wired or wireless link with an external network 301, which can be a public or private network or a combination of public and/or private networks. Personal computing devices 320a-320d are associated with digital wallet holders who may enter smart contracts with the NFT-based trading card asset platform 350 to mint an NFT-based trading card asset and hold it in their digital wallet. The total number of wallet holders who may enter smart contracts to buy/hold/sell NFT-based trading card assets may be any number and, as such, the depiction of just four devices 320a-320d is not an indication that embodiments of the solution are limited to use by and among just four users. Running apps associated with a host platform 350 for NFT-based trading cards and/or a digital wallet, the handheld devices 320a-320d can be used to perform one or more of the operations described above to communicate with the blockchain system 310 via the network 301.

The nodes 330₁-330_{N} are interconnected by a network that allows them to communicate with one another, and each of the nodes 330₁-330_{N} comprises one or more processors that are configured to allow the nodes to perform blockchain operations such as those described above. NFT-based trading card asset platform 350 may itself be considered a node of the blockchain system 310. The processors of the nodes do not all have to have the same configurations and do not all have to perform the same operations.

When the processes described above are performed to trigger creation of a new NFT-based trading card asset, or creation of a protective device NFT, or modifying the digital content of an NFT-based trading card asset, or trading or selling an NFT-based trading card asset, a new block associated with the resulting NFT is added to the blockchain. The blocks 331₁-331_{M} in the illustration represent the blocks of the blockchain and the lines interconnecting the blocks 331₁-331_{M} represent the encryption that links the blocks together in the blockchain, where M is a positive integer that is greater than or equal to 1. The blockchain comprising the cryptographically-linked blocks 331₁-331_{M} is essentially the distributed ledger of the blockchain network 300.

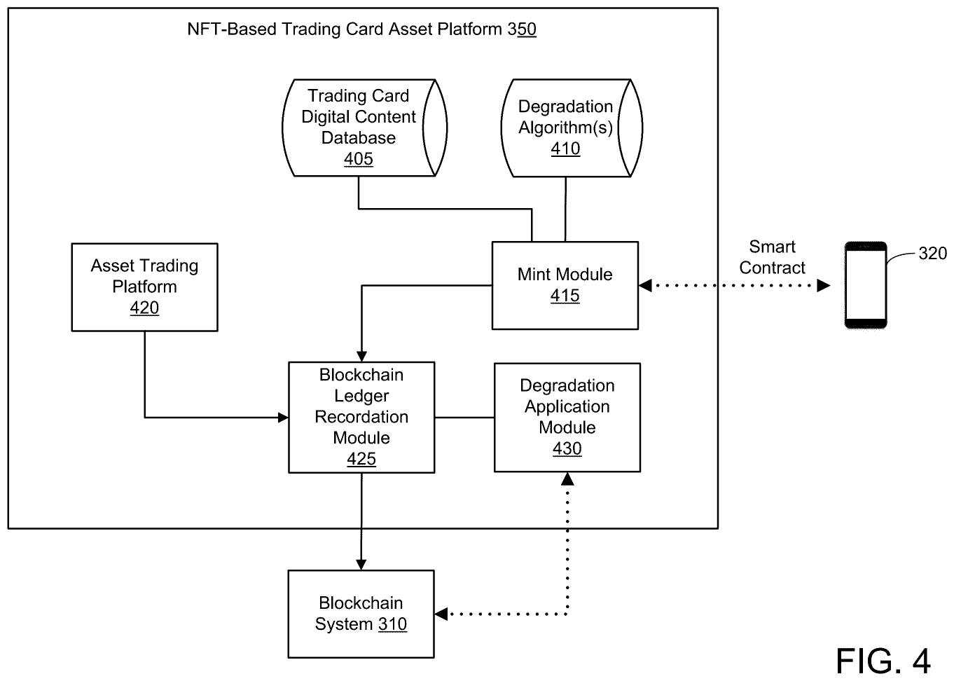

FIG. 4 is a more detailed block diagram of the NFT-based trading card asset platform 350 depicted in the FIG. 3 illustration. Consistent with that which has been previously described, a user of a computing device 320 may enter into a smart contract with the platform 350 by causing the mint module 415 to generate an NFT-based trading card asset. The mint module 415 may pull digital content of a trading card, such as a baseball athlete picture and related statistics, from a trading card digital content database 405. The mint module 410 may also pull the code that forms a degradation algorithm in the smart contract from a database of degradation algorithms 410. Alternatively, component 410 may be in the form of a direct data, as opposed to a database per se, that the mint module 415 incorporates into a smart contract when minting an NFT-based trading card asset. The component 410 and/or the component 405 may be within the mint module 415 but are depicted separately in the FIG. 4 illustration for ease of understanding.

Once minted, an NFT-based trading card asset may be recorded on the blockchain system 310 in association with a digital wallet of computing device 320 by blockchain ledger recordation module 425. The degradation application module 430 may execute the embedded degradation algorithm in the smart contracts if/when triggering events occur that may decrement the grade of the digital content in an NFT-based trading card asset. Notably, platform 350 may be considered a node of the blockchain system 310 and so degradation application module 430 is depicted as a component of platform 350 for ease of understanding; however, and as one of ordinary skill in the art would understand, the smart contracts of NFTs are self-executing and so may be executed by any processor, or combination of processors, within the blockchain system 310.

Additionally, the NFT-based trading card asset platform 350 may include an asset trading platform 420 that provides a digital marketplace for holders 320 of NFT-based trading card assets to publicly display, trade and/or sell NFT-based trading cards. Notably, each time the digital content of an NFT-based trading card asset is displayed, traded and/or sold through asset trading platform 420 (or any other asset trading platform within the network 300), the recordation on the blockchain system 310 may be updated or amended to include a derivative digital content and/or new owner/holder.

The Appendix provides an exemplary rendering of the digital content of an NFT-based trading card asset according to an exemplary embodiment of the solution, shown in stages of an exemplary “degradation” according to the application of a degradation algorithm dictated by a smart contract associated with the NFT-based trading card asset. The digital contents, when rendered, feature “metal” trading cards in various stages degradation due to rust.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Therefore, although selected aspects have been illustrated and described in detail, it will be understood that various substitutions and alterations may be made therein without departing from the spirit and scope of the present invention, as defined by the following claims.

What is claimed is:

1. A method for NFT-based trading card assets, comprising generation of an NFT-based trading card asset by minting a nonfungible token (NFT) representative of an initial digital content operable to be visually displayed on a computing device, wherein the minted NFT-based trading card asset is recorded on a blockchain and comprises a smart contract that includes a degradation algorithm, the degradation algorithm operable when executed to modify the initial digital content into a derivative digital content.

2. The method of claim 1, wherein the initial digital content represents one of a sports trading card, a gaming card, and a ticket.

3. The method of claim 1, further comprising:
assigning a first grade to the initial digital content, wherein the first grade is associated with a grading system and is representative of a first visual defect dataset associated with the initial digital content.

4. The method of claim 3, further comprising:
in response to a triggering event, executing the degradation algorithm to generate a derivative digital content having a second visual defect dataset;
assigning a second grade to the derivative digital content, wherein the second grade is associated with the grading system and is representative of the second visual defect dataset associated with the derivative digital content;
updating the blockchain to record that the NFT represents the derivative digital content.

5. The method of claim 4, wherein the derivative digital content, when visually displayed, represents a trading card and the second visual defect dataset comprises one or more of a tear, a stain, a crease, a worn corner, a fade, a discoloring, and a loss of gloss.

6. The method of claim 4, wherein the triggering event is a rendering of the digital content.

7. The method of claim 4, wherein the triggering event is a sale of the NFT.

8. The method of claim 4, wherein the triggering event is associated with a time lapse.

9. The method of claim 3, further comprising:
linking a protective device NFT to the NFT-based trading card asset;
in response to a triggering event, executing the degradation algorithm to generate a derivative digital content having a second visual defect dataset, wherein the linked protective device NFT operates as an input to the degradation algorithm to affect the scope of the second visual defect dataset;
assigning a second grade to the derivative digital content, wherein the second grade is associated with the grading system and is representative of the second visual defect dataset associated with the derivative digital content;
updating the blockchain to record that the NFT represents the derivative digital content.

10. The method of claim 9, wherein the derivative digital content, when visually displayed, represents a trading card and the second visual defect dataset comprises one or more of a tear, a stain, a crease, a worn corner, a fade, a discoloring, and a loss of gloss.

11. The method of claim 9, wherein the triggering event is a rendering of the digital content.

12. The method of claim 9, wherein the triggering event is a sale of the NFT.

13. The method of claim 9, wherein the triggering event is associated with a time lapse.

14. A system for NFT-based trading card assets, comprising:
a digital content database comprising a plurality of initial digital contents;
a blockchain ledger recordation module; and
a minting module configured to generate an NFT-based trading card asset by minting a nonfungible token (NFT) representative of an initial digital content queried from the digital content database and operable to be visually displayed on a computing device, wherein the minted NFT-based trading card asset comprises a smart contract that includes a degradation algorithm, the degradation algorithm operable when executed to modify the initial digital content into a derivative digital content; and
wherein the minted NFT-based trading card asset is recorded on a blockchain by the blockchain ledger recordation module.

15. The system of claim 14, wherein the initial digital content represents one of a sports trading card, a gaming card, and a ticket.

16. The system of claim 14, wherein the minting module is further configured to:
assign a first grade to the initial digital content, wherein the first grade is associated with a grading system and is representative of a first visual defect dataset associated with the initial digital content.

17. The system of claim 16, wherein:
in response to a triggering event, the degradation algorithm self-executes to generate a derivative digital content having a second visual defect dataset and assign a second grade to the derivative digital content, wherein the second grade is associated with the grading system and is representative of the second visual defect dataset associated with the derivative digital content; and
a node in a blockchain network updates the blockchain to record that the NFT represents the derivative digital content.

18. The system of claim 17, wherein the derivative digital content, when visually displayed, represents a trading card and the second visual defect dataset comprises one or more of a tear, a stain, a crease, a worn corner, a fade, a discoloring, and a loss of gloss.

19. The method of claim 17, wherein the triggering event is one of a rendering of the digital content and a sale of the NFT.

20. The method of claim 17, wherein the triggering event is associated with a time lapse.
